(19) United States
(12) Patent Application Publication
(10) Pub. No.: US 2003/0215316 A1
(43) Pub. Date: Nov. 20, 2003

(54) Access ramp having self-contained hydraulics and improved bushing assembly

(76) Inventors: Donald Joe Burney, Weaver, AL (US); O. Alvin Thacker, Ohatchee, AL (US); Ronald T. Thacker, Alexandria, AL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/334,646

(22) Filed: Jan. 1, 2003

Related U.S. Application Data
(60) Provisional application No. 60/359,922, filed on Feb. 27, 2002.

(51) Int. Cl. B60P 1/00

(52) U.S. Cl. 414/537

(57) ABSTRACT

Therefore it may be seen that the present disclosure includes the description of a system, particularly the First System 100, which include advantages over the known prior art by providing a wheelchair ramp subassembly which includes the use of internal hydraulics, such that the subassembly can use its own hydraulics which do not need to be shared with other hydraulic units on the supporting vehicle. This provides an apparatus that includes improved operating characteristics, tends not to be contaminated through shared hydraulic connections, and can operate conditions in a manner not possible if connected to a shared hydraulic system. An improved bushing 1005 is also provided.

### CROSS REFERENCE TO RELATED APPLICATION

This application claims the benefit of provisional patent application Serial No. 60/359,922 filed Feb. 27, 2002. The present application claims the full benefit and priority of said application, and incorporates the entire contents of same by reference.

### FIELD OF THE INVENTION

The present invention relates generally to ramps, and more particularly relates to ramps used to provide access to vehicles. Such vehicle ramps are sometimes known as “wheelchair ramps” and can be selectively moved in and out of place in order to allow selective access by wheelchairs from surfaces such as sidewalks or streets.

### BACKGROUND OF THE INVENTION

Wheelchair ramps are often used in order to allow wheelchair or stepless access to a bus or similar vehicle. Such ramps typically have to be deployed from a retracted position to an extended position. They are usable in the extended position. Such mechanisms encounter occasional rough handling and this have to be resilient, yet they need to operate in a smooth, controlled, and reliable manner. Improvements to such systems are always in demand.

### SUMMARY OF THE INVENTION

In summary, the present invention relates to the use of internal hydraulics in a wheelchair ramp subassembly, and also relates to the use of an improved bushing assembly.

Generally described, the present invention is directed towards the use of internal hydraulics in a wheelchair ramp subassembly, such that the subassembly can use its own hydraulics which do not need to be shared with other hydraulic units on the supporting vehicle.

More particularly described, the present invention is directed towards use of internal hydraulics in a wheelchair ramp subassembly, in which said internal hydraulics include the use of hydraulic fluid which includes different characteristics than the hydraulic system included in the main vehicle (e.g., the bus).

More particularly described, the present invention is also directed towards use of an improved bushing assembly which is reliable yet tamper resistant.

Therefore, it is an object of the present invention to provide an improved wheelchair ramp subassembly for use in a supporting vehicle.

It is a further object of the present invention to provide an improved wheelchair ramp subassembly for use in a supporting vehicle such as a bus.

It is a further object of the present invention to provide an improved wheelchair ramp subassembly which is efficient in operation.

It is a further object of the present invention to provide an improved wheelchair ramp subassembly which is reliable in operation.

It is a further object of the present invention to provide an improved wheelchair ramp subassembly which is effective in operation.

It is a further object of the present invention to provide an improved wheelchair ramp subassembly which can withstand certain environmental rigors such as cold temperatures.

Other objects, features, and advantages of the present invention will become apparent upon reading the following detailed description of the preferred embodiment of the invention when taken in conjunction with the drawing and the appended claims.

### BRIEF DESCRIPTION OF THE DRAWINGS

Having thus described the invention in general terms, reference will now be made to the accompanying drawings, which are not necessarily drawn to scale.

FIG. 1 is a pictorial view of the modular wheelchair ramp subassembly 10 (a.k.a. modular wheelchair ramp assembly 10) according to the present invention, configured to be placed into service into a bus (not shown in this figure but shown in FIG. 14) or other suitable vehicle.

FIG. 2 is an exploded view which illustrates both the First System 100 (if element 60 is used) and the Second System 200 (if element 201 is used).

FIG. 3 is a pictorial view showing an assembled, and a disassembled, view of linkages used in conjunction with the bushing 1000.

FIG. 4 is a pictorial view, both assembled and disassembled, of a configuration which includes the use of the bushing 1000, and an associated shim washer 1001 and roll pin 1002.

FIG. 5 is an illustrated view illustrating the various elements of the bushing assembly 1005, including bushing 1000, shim washer 1001 and roll pin 1002.

FIG. 6 is an isolated pictorial view of the bushing 1000 according to the present invention, including head section 1100, bearing section 1200, and fixing section 1300.

FIG. 7 is a perspective, as well as plan and elevational views of the bushing 1000 according to the present invention. The dimensions shown are for illustrative purposes only and should not be construed as limiting.

FIG. 8 is a pictorial installation of the bushing 1000 according to the present invention, shown in conjunction with two linkage members. It should be understood that the shim washer 1001 and roll pin 1002 are not shown in this view.

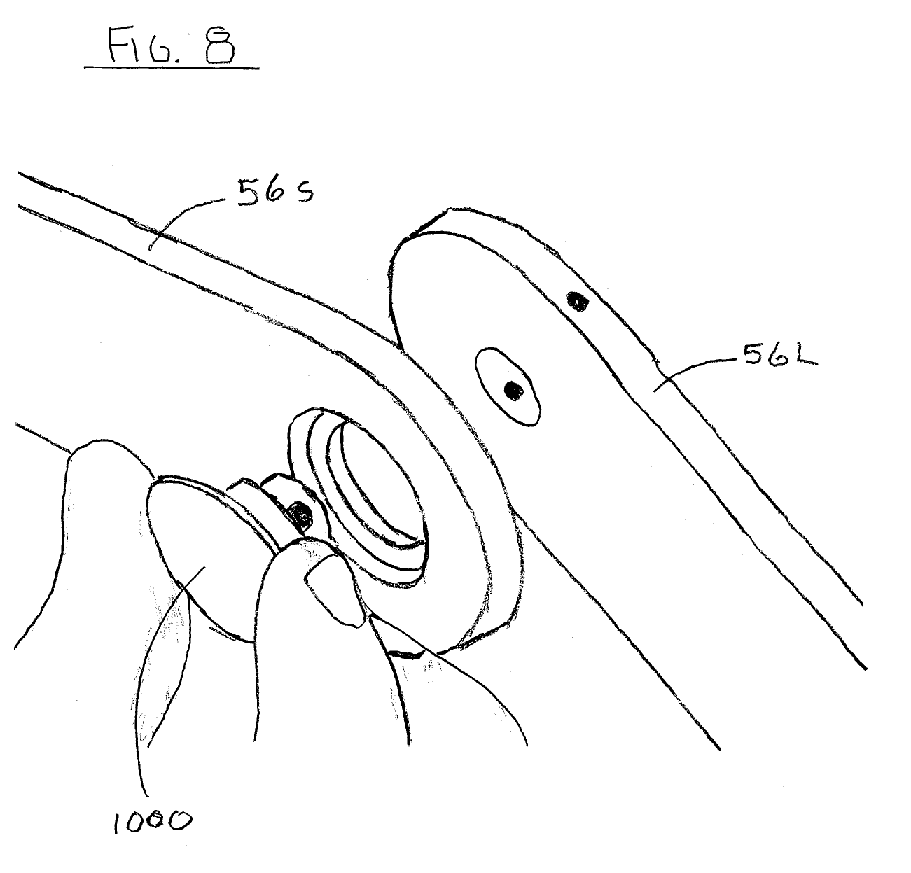

FIG. 9 is a view similar to that of FIG. 8, except in this instance, bushing 1000 is shown installed, the shim washer 1001 is not shown (it is concealed), and the roll pin 1002 is in the process of being inserted.

FIG. 10 is a view similar to that of FIG. 9, with a slightly wider angle view, with the roll pin 1002 shown in its installed position, which as may be seen is difficult to tamper with without the proper tools.

FIG. 11 is an illustration of the use of the bushing 1000 according to the present invention (shown held by a human hand), used in conjunction with a “wrist”-type connection in which an elongate member is attached to a ramp side flange 31. In this view, the bushing 1000 is shown, but the shim washer 1001 and roll pin 1002 are not shown.

FIG. 12 is a pictorial view showing the bushing 1000 in its installed configuration, with the roll pin 1002 being positioned for installation and the shim washer concealed.

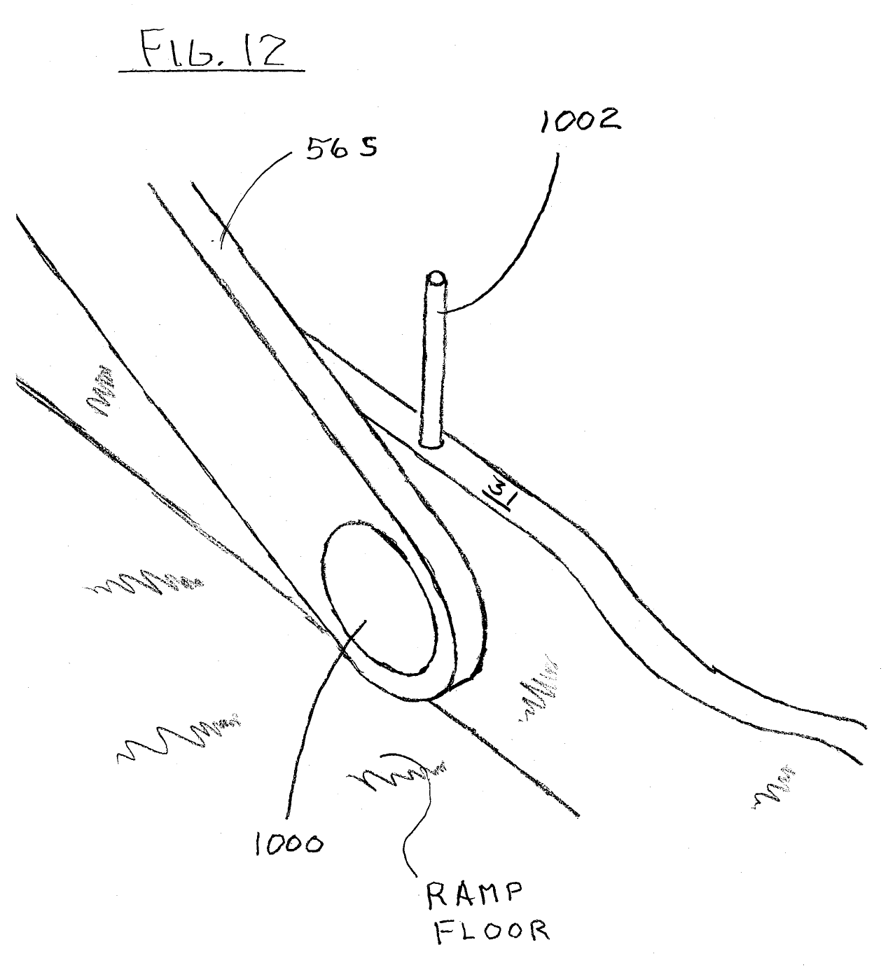

FIG. 13 is a view similar to that of FIG. 12, except the roll pin 1002 is installed. Note the floor of the ramp in the bottom left section of the drawing.

FIG. 14 is a illustrative view of a bus 9 or other vehicle including a first set of hydraulics 8 which operate elements such as power steering for the front wheels 7 and which also includes a second set of hydraulics which operate a modular wheelchair ramp subassembly 10.

FIG. 15 is a hydraulic schematic for the First System 100.

### DETAILED DESCRIPTION OF THE INVENTION

The present invention now will be described more fully hereinafter with reference to all of the accompanying drawings, figures, and photographs in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The invention relates specifically to hydraulically driven wheelchair ramp assemblies, such as assemblies that are relatively self-contained units which are installed as a unit into a bus or other similar vehicle.

First, two ramp assembly systems will be discussed separately, a First System 100 and a Second System 200. Although a “bus” may be used as an example of a vehicle with which the ramp assemblies may be used, it may readily be understood that other vehicles may be used which include the use of a ramp assembly without departing from the spirit and scope of the present invention.

I. First System 100

Generally described, the first wheelchair ramp subassembly system 10 includes the following elements:

Basic framework 20

Pivoting ramp 30

Framework top cover 40

Rotary actuator 50

Linkage assembly (including linkages) 56

Hydraulic pump subassembly 60

Control system 70

More details will now be discussed.

Framework 20

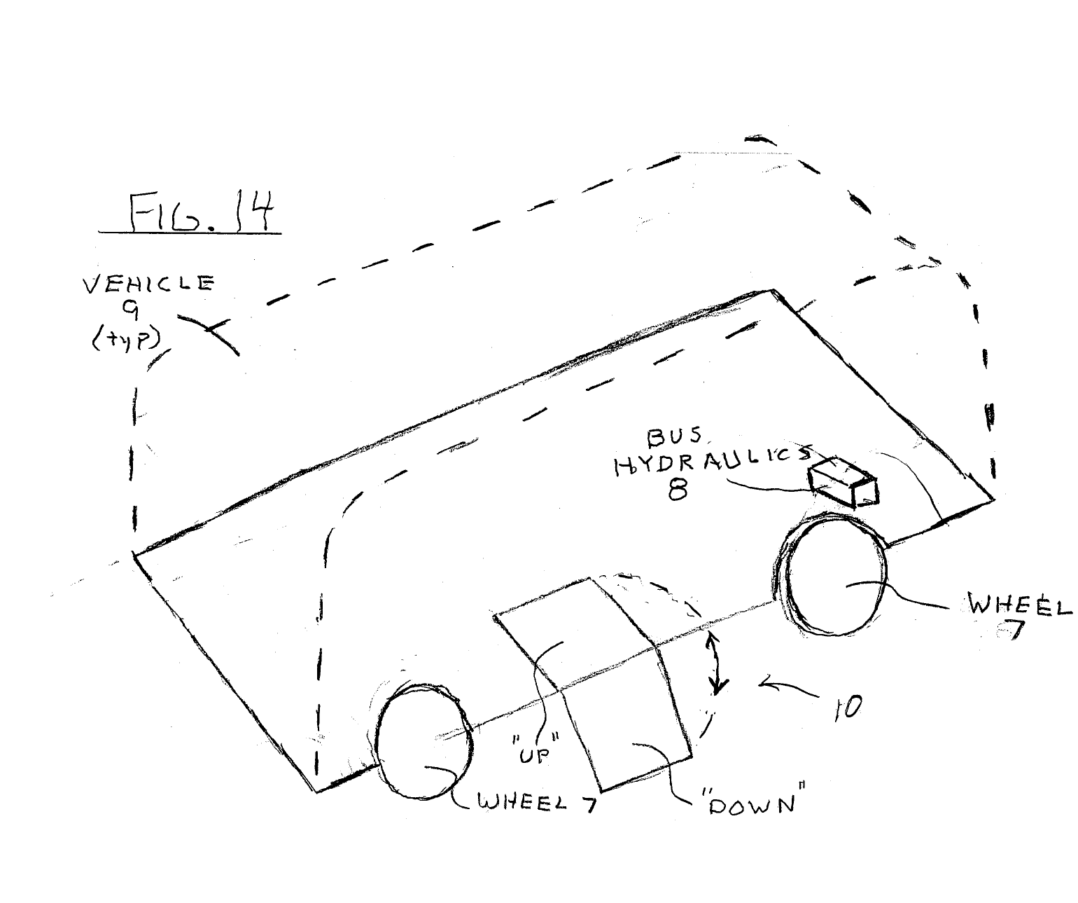

The framework 20 is configured to be attached relative to the framework of a bus (see FIG. 14) or other suitable vehicle. This framework 20 is also configured to support various elements of the subassembly, including the elements 30, 40, 50, 56, 60 and 70.

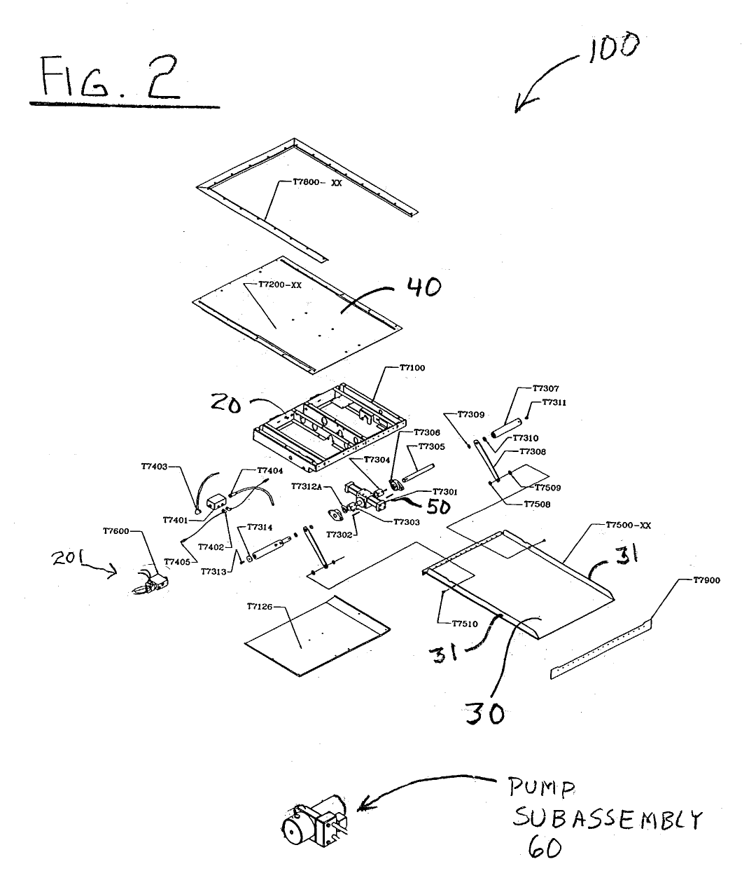

Reference is particularly made to FIG. 2, which shows framework 20 (also denoted as “T7100” in FIG. 2), which includes a generally rectangular perimeter made of elongate frame members, within which various generally elongate “rib”-type members extend. All of these various elongate members will be generally referred as “frame members.”

Pivoting Ramp 30

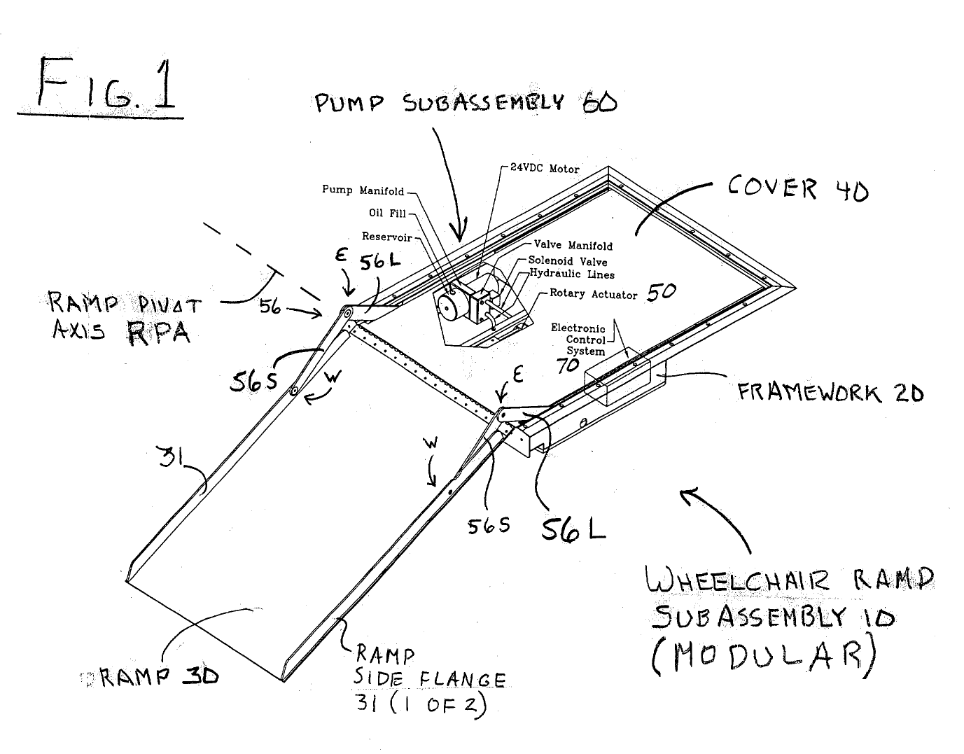

The pivoting ramp 30 is configured to be pivotably attached relative to the “front” edge of the framework, such that it pivots about ramp pivot axis RPA shown in FIG. 1.

This ramp is generally conventional, and pivots from a withdrawn, stored, position to an extended, enabled, position. The ramp is configured to support the weight of a user; depending on the position, the user will contact one or the other side of the ramp.

As may be seen in FIG. 1, the ramp 30 includes two side flanges 31, which extend upwardly at a generally 90 degree angle from the ramp floor. These side flanges are substantially platelike in that they have a substantially nominal thickness defined by two opposing primary planar surfaces lying in parallel planes. In each instance one primary planar surface faces away from the ramp path and the other primary planar surface faces the ramp path and serves as a containment guide should the wheelchair tend to veer off the ramp.

Top Cover 40

The top cover 40 is configured to be removably attached to the top of the framework to conceal and contain various elements located therein. The cover is also configured to support the weight of a user when the ramp is extended.

Rotary Actuator 50

The rotary actuator 50 is configured to convert hydraulic pressure, provided to its two input ports, into rotary motion. Two hydraulic lines go into the input ports rotary actuator, one line going into each end.

This actuator 50, has an output shaft configured to rotate in either direction. Upon receipt of pressure in a “first” input port, rotation is in a “first” direction. Upon the direction of high pressure in a “second” input port, rotation is in a second direction, which is opposite to the first direction.

As will be seen in later discussion, such alternating rotation is used to alternately extend and withdraw the ramp, though the use of suitable linkages intermediate the output shaft at the rotary actuator 50 and the pivoting ramp 30. In one configuration, the line that comes in towards the rear of the ramp, furthest inside the bus, is the one that gets pressurized when the ramp opens.

Linkage Assemblies 56

These are two-segmented, linkage assemblies 56 with one linkage 56L (a.k.a. the “long arm”) having one end rigidly attached to the shaft of the rotary actuator, and the second end of the first segment pivotably attached to the first end of the second segment 56S. The second end of the second segment 56S (a.k.a. the “short arm”) is pivotably attached to the ramp. Operation is conventional, although an inventive bushing assembly 1005 described later may be used to provide improved pivoting functions as later described. These linkages likewise may be seen to be platelike, and are defined by two opposing primary planar surfaces lying in parallel planes.

Hydraulic Pump Subassembly 60

The hydraulic pump subassembly 60 is configured to convert electrical power into hydraulic pressure, output to one of two hydraulic ports.

The hydraulic pump assembly 60 includes an electrical motor (preferably configured to accept DC current (e.g. 24 volt) from the vehicle), the electrical motor driving a hydraulic pump. Also included is a solenoid valve configured to control to which of the two hydraulic parts the hydraulic pressure is provided. Also provided is a suitable reservoir, within which a gear or other suitable pump is located).

Operation at this solenoid valve is provided by an electrical control line, operably attached to the control system 70, as discussed later.

The two hydraulic ports of the hydraulic pump subassembly are connected to two hydraulic lines that lead to two corresponding ports on the rotary actuator. By suitably controlling the solenoid valve, hydraulic pressure can be supplied to either of the two hydraulic lines, thus selectively rotating the rotary actuator in the desired direction. It may be understood that when one of two connecting lines is the “high pressure” line, the other is the “low pressure” line which returns fluid to the pump subassembly 60. Pressure bypass is internal to this unit.

The pump subassembly 60 is mounted to one of the frame members of the frame with a couple of bolts. For example, on one of the side frame members on the left side, two bolts pass through a spacer and then right into the pump; there are two boltholes in the side of the pump. FIG. 1 is a cut away view looking from the top and showing where the pump subassembly 60 is mounted; the viewer can actually see the rib it is mounted to.

When mounted in the nature described above, the longitudinal axis of the DC motor of the pump subassembly 60 is substantially parallel to the walking path direction.

Control System 70

The control system 70 is configured to control the operation of the overall ramp subassembly 10.

The control system 70 has an input (typically supplied by suitable controls in the operator's region) which includes an “Extend” and a “Retract” signal. When either of those signals is received, the system 70 causes the pump in the pump subassembly 60 to begin pumping. Directional control of the fluid is provided by reversing the electrical motor, which is done by reversing its polarity by use of a suitable relay.

As may be understood, this allows an operator to operate extension and retraction of the ramp.

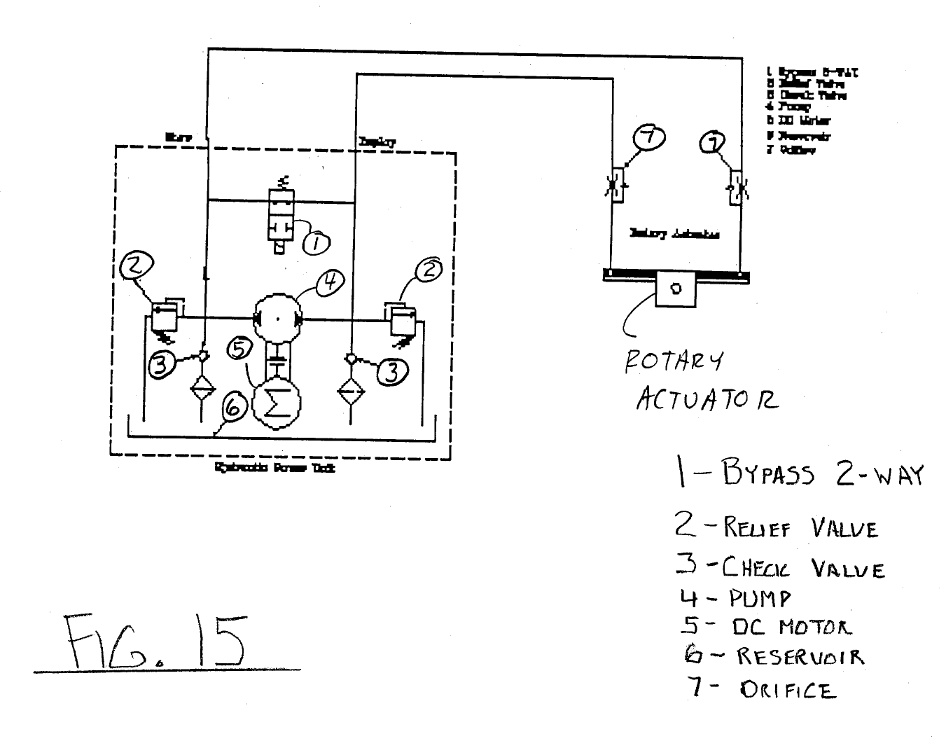

Hydraulic Schematic (See FIG. 15)

Reference is now made to FIG. 15, which shows a hydraulic schematic of the First System. For purposes of discussion of this figure only this shows the following elements:

“1”—Bypass 2-way switch

“2”—Relief Valve

“3”—Check Valve

“4”—Pump

“5”—DC Motor

“6”—Reservoir

“7”—Orifice

The element “1” is spring loaded to allow for passage of fluid therethrough when in the shown position, but not to allow fluid passage when in an “energized” position which moves the switch body upwardly against the spring. As will be discussed later, this energizing is done when the DC motor is energized in either of its two rotational directions.

The two items “2” allow for pressure relief should the rotary actuator (which drives the ramp) becomes blocked (typically when the ramp is blocked).

The check valves “3” are essentially one-way valves which prevent fluid passage back down into the reservoir “6”.

The two orifices “7” are in fact modified one-way valves, each modified with a drilled 0.010 inch hole to provide relatively free flow in one direction, with a 0.010 hole presented in the opposite direction, providing flow control.

The pump “4” is driven by a reversible DC motor “5”, such that by reversing the polarity of the motor, fluid can be pumped to the selected one of the two lines to the rotary actuator. When the motor is energized, regardless of the direction, the element “1” is energized to cause movement of the element “1” to the position not shown, which results in no flow through element “1”.

When the motor “5” is not energized (power off), the element “1” goes to the position shown, and the rotary actuator (and the ramp) can be moved manually (such as may be needed in a power failure) with recirculation provided by element “1”.

II. Second System 200

The Second System is hydraulically operated system, except the hydraulic fluid and the hydraulic pressure is provided by the bus hydraulics system. This is the same hydraulic system which might operate other hydraulically driven components on the bus, such as a power steering component.

Instead of a self-contained pump assembly as used in the First System, as shown in FIG. 2, the Second System includes the use of a manifold unit 201 (also denoted as T7600). This manifold unit 201 is configured to accept two or more hydraulic lines, including a pressurized or “high side” line, as well as one or more pressurized or “low side” lines. This unit in one configuration is mounted to the back wall of the frame through some bulkhead fittings, although it can be mounted elsewhere.

III. Different Features, Actions, and Advantages Between the Two Systems

As may be understood, the two systems include different features, actions, and advantages. Particularly, the differences will be discussed from the point of view of the First System versus the Second System.

Different Features

The First System 100 has its own hydraulic pump and associated reservoir, compared to the manifold unit 201 of the Second System 200.

Bus hydraulics are not used in the First System, as the First System 100 has its own dedicated hydraulic system, which is totally isolated from the bus hydraulics. The only thing used from the bus system is in the First System 100 is electrical power. In both systems a similar five- (5) cord electrical connector is provided between the systems and the bus or other vehicle. The First System requires additional amperage to drive the pump, but does not require separate hydraulics. The First System 100 in one embodiment requires at least 10 amps for operation. The Second System 200 could require around 2 amps. Control connections are essentially the same.

In the First System, pressure relief is in the pump housing. In the Second System, pressure relief is in the manifold.

Actions

The actions of the two systems are different. Compared to the First System 100, the Second System 200 has a tendency to “vault” out of the floor for a certain distance during which it would come up to high speed, and then would be under control for the rest of its stroke. This tendency is particularly evident when the units has been unused for a period of time, sufficient to allow the pressure to bleed out of the rotary actuator.

The First System 100 does not tend to exhibit such vaulting; because of its construction it will have a tendency to “ramp up” in pressure, in other words to build pressure slowly, and thus come up in a more controlled fashion. This provides smooth acceleration and smooth deceleration.

The reason for this is as follows. In the Second System 200 hydraulic system, which includes a manifold and valve inside, there may be 2000 PSI on the line coming in. If the valve is then suddenly shifted, there can be a sudden increase of 2000 PSI on the piston on the rotary actuator in a relatively short period of time (assuming bleeding over time as discussed above). Thus this tends to provide a sudden “jerking” effect.

On the First System 100, which includes its own pump, the pump when first switched on (electrically) gradually builds up pressure in the line leading to the rotary actuator. It keeps pumping and “ramping up” pressure until the ramp starts moving. This pressure buildup occurs relatively quickly (less than a second), but it is still long enough, and done in a curved type fashion, to greatly reduce the shock to the system, when compared to the Second System.

If for some reason mechanically the ramp is hung or otherwise blocked, in both systems pressure would be pumped until the pressure release valve setting inside the pump (or the Manifold in the Second System 200) will release pop and the fluid would bypass as known in the art.

Advantages

The First System 100 includes several advantages over the Second System 200. The First System 100 allows use of a self-contained, more modular, hydraulic system. This is advantageous in that the quality and type of the fluid can be better controlled. In the Second System 200, because of use of bus hydraulics and their hydraulic fluid, the designer of the system cannot control how clean the fluid is, or the type of fluid used.

As noted above, in the Second System 200 environment, the same hydraulic fluid flowing through the Second System 200 is also being used in conjunction with other hydraulic units such as a steering mechanism. This is disadvantageous as such an orifice flow controls or the like could be stopped up because of minute trash in the hydraulics.

Another big advantage is that the designer of the Second System 200 is not limited to conventional hydraulic fluid if the ramp does not have to share its fluid. This allows the designer the opportunity to use special fluid that can operate under adverse environments such as cold. For example, with the use of special cold weather hydraulic fluid (e.g. Mobil Aero HFA), the inventor performed a cold soak test, which is a requirement for this ramp to operate at minus 25 degrees instantly. The unit passed with no warm up and no heater.

Another advantage to the First System 100 is ease of installation, in that one does not have to deal with hydraulic lines from the bus as is the case of the Second System 200, the only connections required are electrical. Typically, the bus hydraulic lines have to come through a hole in a frame member on the bus. Unfortunately, the bus company often does not provide such required access holes in frame members at the same place twice, and this requires significant modifications during installation of the hydraulic supply lines of the Second System 200. In contrast, in the First System 100, electrical wiring is much easier to route and connect.

IV. Bushing Assembly

Another invention provided by applicant includes the use of a bushing assembly 1005, which is configured to provide a bearing surface suitable for use within a pivoting connection between two relatively pivoting members. These “two relatively pivoting members” will first be described in general terms, but will also be discussed in more detail by way of example.

General Environment

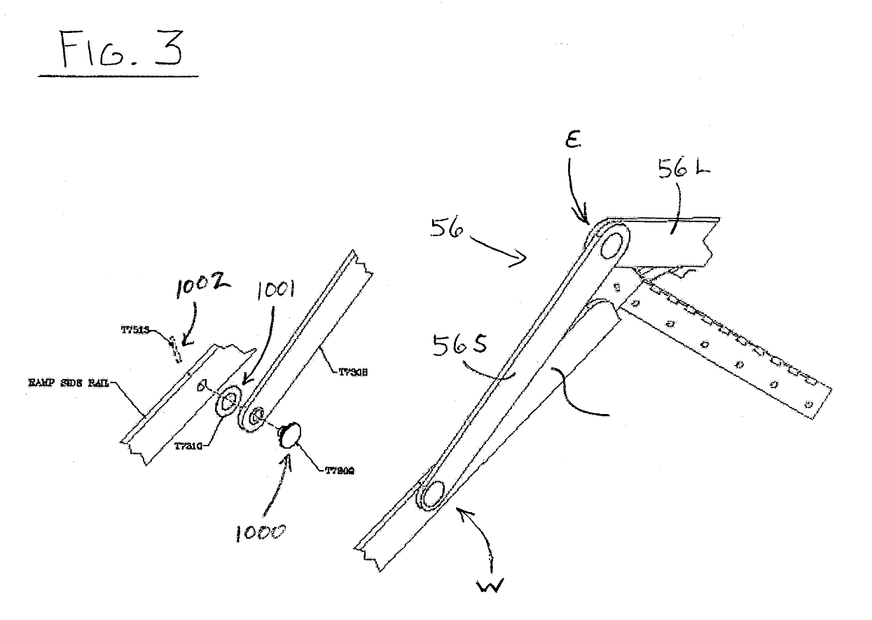

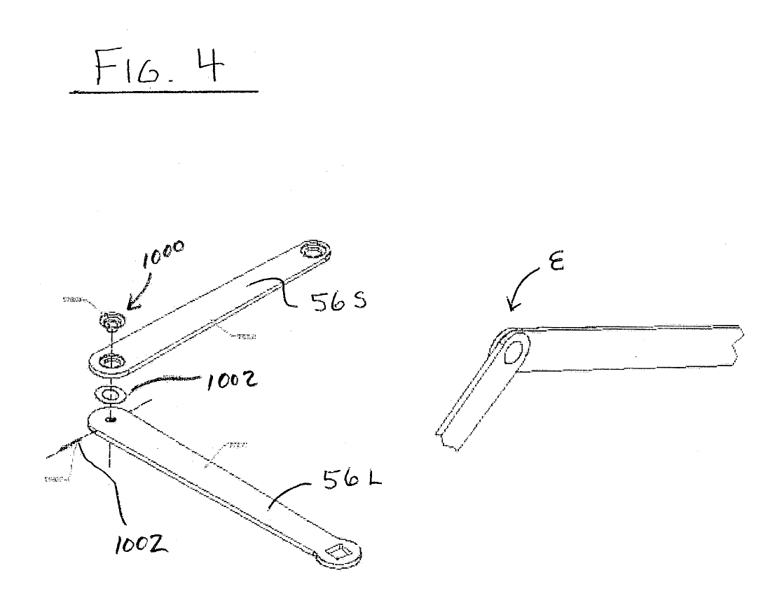

As will be described in later detail, the improved bushing 1000 according to the present invention can be universally used in various locations within the pivoting ramp assembly 10 (See FIG. 1) described above, in a first, “wrist”-type, connection such as denoted as “W” in FIGS. 1, 3 and 13, as well as in a second, “elbow”-type, connection between two elongate linkages (a.k.a. “arms”), shown as “E” in FIGS. 1, 3, 4 and 10. In the first embodiment, one of these pivoting members is an elongate linkage member such as 56S, which is pivotably attached relative to a side flange 31 of a ramp member such as 30 in FIG. 1. In the second pivoting embodiment, both of these pivoting members are linkages such as 56L, 56S from the assembly 56 in FIG. 1.

The bushing assembly provides a detachable pivoting connection between two relatively pivoting members, each of which includes a through hole, and one of which include a bore hole for a roll pin for attachment of the bushing thereto.

General Construction and Operation of Bushing Assembly 1005

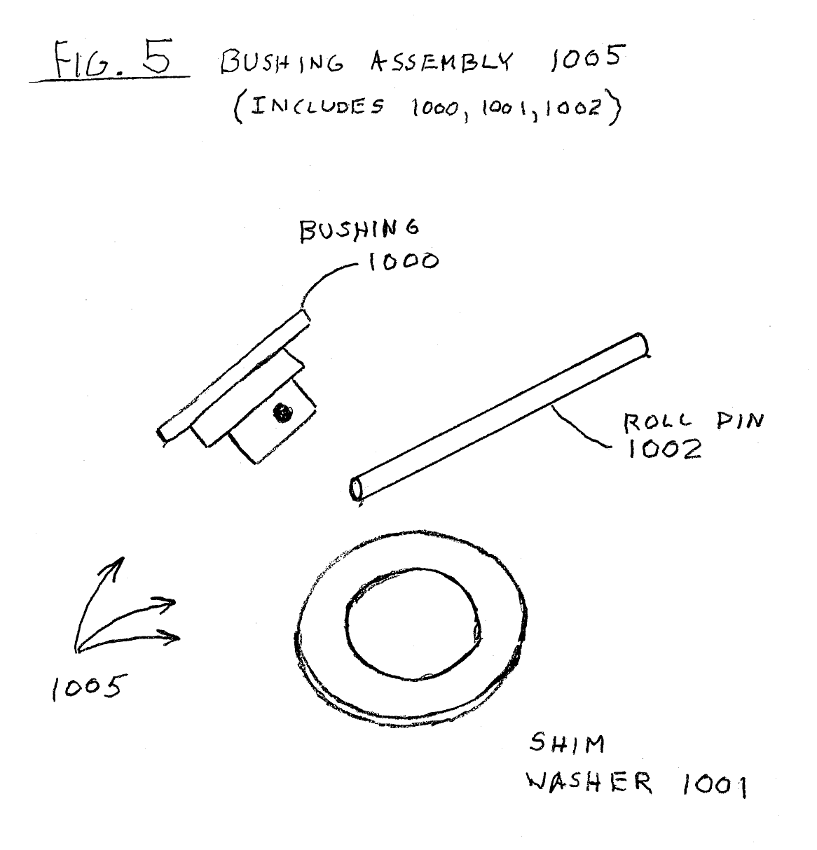

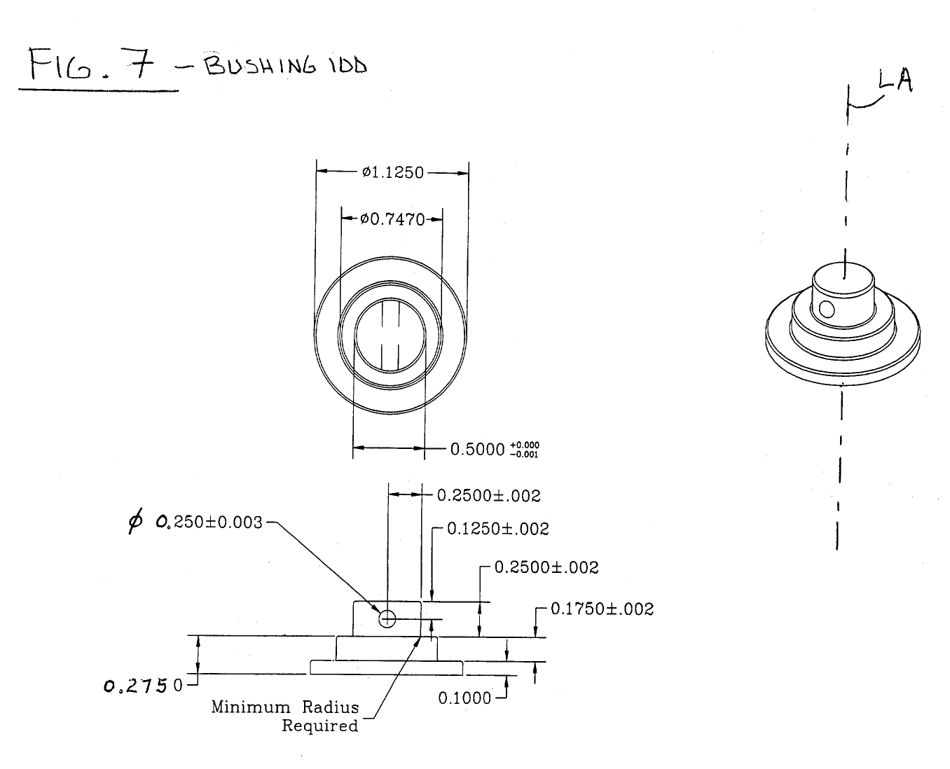

Generally described, referring now to FIG. 5, the bushing assembly 1005 includes a bushing 1000, a shim washer 1001, and a roll pin 1002, all configured to be used as a coordinated group of elements to provide a pivoting action between two relatively pivoting members, in order that the pivoting members may pivot relative to each other along an axis, which is substantially common to the longitudinal axis LA (see FIG. 7) of the bushing member 1000, and likewise preferably extends through the centers of the two circular through holes defined by the two pivoting members.

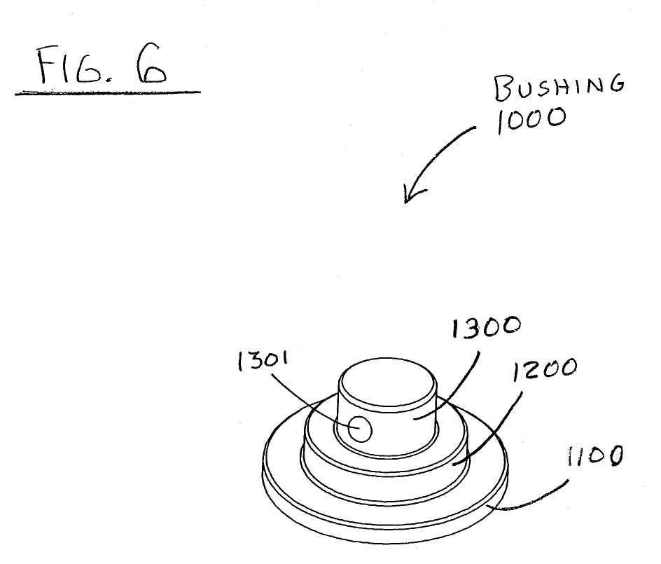

The bushing member 1000 (see FIGS. 6 and 7) is detachably fixed to one of the pivoting members through the use of the roll pin 1002, which extends through a roll pin bore which is partially defined by a section of the bushing member and is partially defined by the first pivoting member. The second pivoting member, which is put into place before the roll pin is installed, is pivotably attached to the first member by use of the bushing member 1000. More particularly, the second pivoting member is configured to rotatably pivot around a section of the bushing member 1000, but is axially captured to prevent axial movement along the bushing member in one axial direction by a head portion of the bushing member 1000, and in the other axial direction by the presence of the first pivoting member.

This provides an effective, reliable, and tamperproof bushing for use in what can be a stressful environment.

Details of the various elements of the bushing assembly 1005 are now provided.

Bushing Element 1000

Reference is now made to FIGS. 6 and 7, which show detailed views of the bushing member 1000 according to one element of the present invention. This bushing element 1000 is composed of three sequential length sections, a first, “head” section 1100, a second, “bearing”, section 1200, and a third, “fixing”, section 1300.

These Sections 1100, 1200 and 1300 are, in one preferred embodiment, all part of a unified single brass element 1000, although other configurations are contemplated without departing from the spirit and scope of the present invention.

The head section 1100 is configured to provide a containment feature for the element, which is pivotably attached relative to the bushing element 1000. This head section 1100 includes an outer diameter, which is greater than the outer diameter of both the other sections 1200, 1300.

The middle, bearing, section 1200 of the bushing element 1000 is configured to provide a bearing surface for one of the two relatively pivoting members. This bearing section 1200 includes an outer circumferencial surface, which defines an outer diameter, which is larger than the diameter of the fixing section 1300, but is smaller than the outer diameter of the head section 1100.

The fixing section 1300 is substantially cylindrical in shape, and is solid, with the exception of a transverse roll pin bore 1301. The fixing section 1300 itself likewise includes an outer circumferencial surface, which defines an outer diameter of, in the embodiment shown, 0.50 inches. This outer diameter is less than the diameter of the fixing section 1300, and thus is less than the outer diameter of the head section 1100.

The fixing element 1300 is configured to be attached relative to one of the two relatively pivoting members by use of the roll pin 1002 which extends through and is frictionally fixed relative to the fixing element 1300, as well as to the one of the relatively pivoting members.

Shim Washer 1001

The bushing member 1000 is configured to be used in conjunction with a shim washer 1001, such as shown in FIG. 5, which includes an internal hole, and a nominal thickness.

This shim washer 1001 is configured to provide a thrust bearing feature between the two relatively pivoting elements, and preferably has its internal bore fitting suitably about the outer diameter of the middle, bearing, section 1200 of the bushing element 1000, when installed.

The shim washer 1001 may be made of suitable brass, stainless steel, or other suitable material, including but not limited to plastics.

Roll Pin 1002

Elements 1000, 1001, are used in conjunction with the roll pin 1002, which as described elsewhere in this application is configured to fit within a roll pin bore hole which extends through the fixing section 1300 as well as one of the pivoting members to detachably fix the two together.

General Installation and Operation

In order to install the bushing assembly 1005 to the two relatively pivoting members, some distinction must first be made between the two pivoting members. This will be done by referencing one as a first relatively pivoting member and the other as a second relatively pivoting member. The bushing 1000 will be fixed to the first relatively pivoting member (e.g., the ramp flange), and will pivot relative to the second relatively pivoting member (e.g., the short arm).

The first relatively pivoting member has a through hole and a roll pin hole, and the second relatively pivoting member has a through hole only.

To install the bushing assembly 1005 such that it links the two relatively pivoting members, the bushing 1000 is first positioned within the second relatively pivoting member, such that the bearing section 1200 of the bushing 1000 is positioned within the bore of the hole of the second relatively pivoting member. The first relatively pivoting member is then positioned relative to the bushing 1000 such that the fixing section 1300 of the bushing 1000 fits within the bore of larger hole of the first relatively pivoting member.

The bushing member 1000 is then angularly oriented such that its transverse roll pin bore 1301 aligns with the roll pin bore provided in the first relatively pivoting member. The roll pin 1002 is then pressed into place, such that it extends both through bores, preferably in a tight frictional relationship such as if the preferred function with roll pins, such that the bushing member 1000 is attached to the first relatively pivoting member via the roll pin 1002. Disinstallation is the reverse of installation. Therefore, it may be seen that the bushing member 1000 pivot relative to the second relatively pivoting member, and is fixed relative to the first relatively pivoting member.

Installation and Operation in First Pivoting Connection—Arm to Ramp

As noted above, the bushing assembly combines to provide a suitable detachable pivoting connection between two “relatively pivoting members”. In one instance, these two relatively pivoting members can be a linkage member 56S (a.k.a. the “short arm”) and a pivoting ramp member 30 such as shown in FIG. 1. This type of connection could also be referred to as a “wrist”-type connection, to facilitate pivoting between the linkage member 56S and one of the side flanges 31 of the ramp member 30 as the ramp member pivots relative to the overall assembly 10.

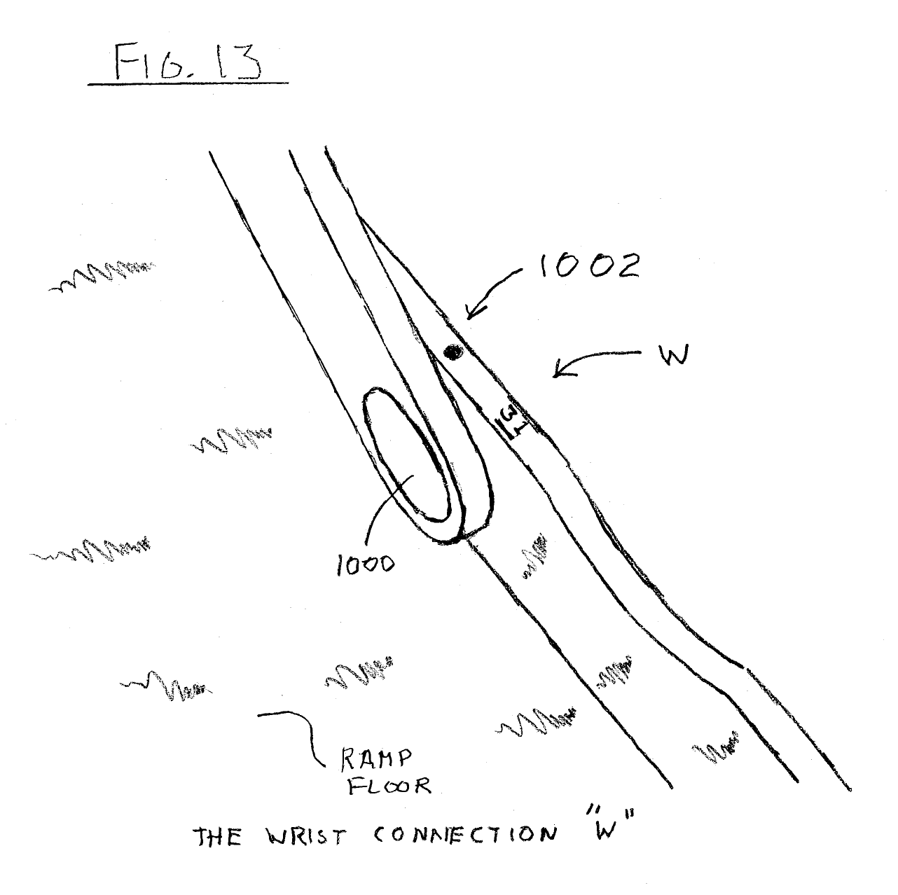

The relevant end of the linkage member 56S preferably includes a hole which is configured to mate with the outer diameter of the bearing section 1200 of the bushing member 1000, such that the linkage member 56S can pivot about the bearing section 1200 of the bushing member 1000. This hole is actually “stepped” to allow a relatively flush mounting of the bushing member 1000 within the linkage member 56S as shown in FIG. 13.

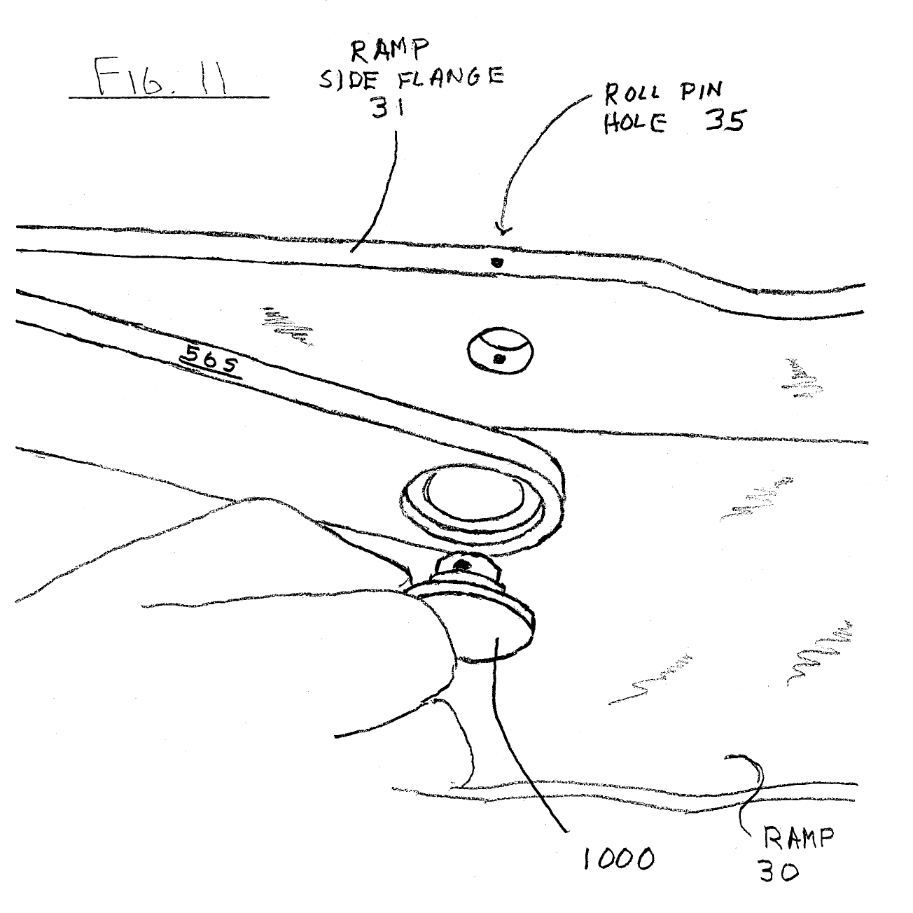

The ramp member 30 includes two platelike side flanges 31, one of which is associated with the pivoting connection under discussion. This side flange 31 likewise includes a through hole 34 as shown in FIG. 11, which is smaller in diameter than the hole in the above-mentioned linkage member, said hole 34 sized to accept the outer diameter of the fixing section 1300 of the bushing member 1000. The side flange 31 likewise includes a roll pin hole 35, which in one embodiment is a hole which is drilled along an axis which is parallel to the primary planar surfaces of the substantially platelike side flange 31, and perpendicular to the bore axis of the bushing-accepting hole in the side flange 31. This will be also referred to as a hole “drilled through the center of the thickness” of the side flange 31. Such drilling is done all the way through the flange so the roll pin can be pushed through in case of a need for removal.

Installation and Operation in Second Pivoting Connection—Arm to Arm

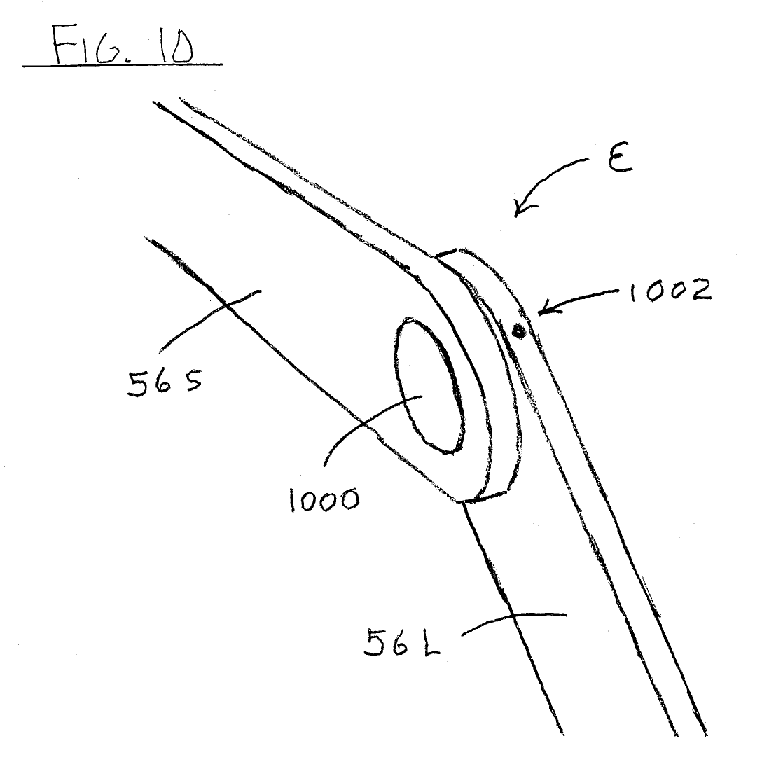

In the second configuration, the bushing assembly 1005, which is comprised of the bushing 1000, the shim washer 1001, and the roll pin 1002, is configured to provide a pivoting connection between two elongate linkages 56S, 56L such as shown in FIG. 10. This could be thought of as an “elbow”-type of connection using the human body as a reference.

The first linkage 56L can also be considered the “long arm” and the second linkage 56S may be considered the “short arm”.

The long arm is configured to have one end rigidly attached to a reciprocating, rotating, shaft, as described above. The other end of the long arm 56L is attached at an “elbow” type connection E to the first end of the short arm 56S. As discussed above, the other end of the short arm 56S is pivotably attached relative to the ramp 30, which is itself likewise pivotably attached relative to the overall frame of the apparatus.

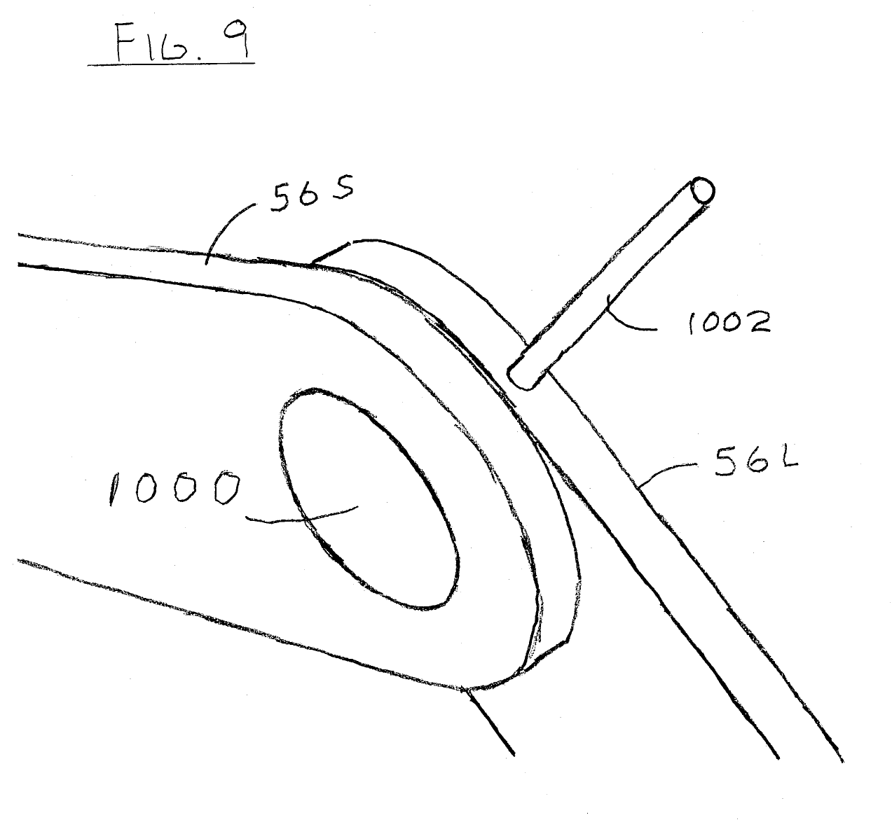

In the instance of the “elbow” connection, the roll pin bore hole is drilled through the long arm 56L as shown in FIGS. 9 and 10, such that the drilling access is substantially parallel to the primary planer surfaces of the long arm 56L, and the drill axis is likewise positioned approximately between the opposing plainer surfaces. Furthermore, the drill axis preferably intersects the center bore access of the hole in the long arm 56L.

Advantages

As may be understood, the bushing assembly 1005 provides an effective, reliable, yet relatively tamper proof configuration which does not include threaded or other similar connections which can vibrate loose. The configuration 1005 also provides a relatively “clean” and smooth configuration, which provides minimal risk of snagging.

Elements List

10 wheelchair ramp subassembly

20 Basic framework

30 Pivoting ramp

31 Ramp pivot axis

40 Framework top cover

50 Rotary actuator

56 Linkage assemblies

60 Hydraulic pump subassembly

70 Control System

100 First System

200 Second System

1000 Bushing

1001 Shim washer

1002 Roll Pin

1003

1005 Bushing Assembly

1100 Head Section

1200 Bearing Section

1300 Fixing Section

V. Conclusion

Therefore it may be seen that the present disclosure includes the description of a system, particularly the First System 100, which include advantages over the known prior art by providing a wheelchair ramp subassembly which includes the use of internal hydraulics, such that the subassembly can use its own hydraulics which do not need to be shared with other hydraulic units on the supporting vehicle. This provides an apparatus that includes improved operating characteristics, tends not to be contaminated through shared hydraulic connections, and can operate conditions in a manner not possible if connected to a shared hydraulic system.

The present disclosure also discloses an improved bushing configuration 1005 which is effective yet relatively tamper-resistant.

1. An improvement in a vehicle for providing wheelchair access, said vehicle having a frame and also including a vehicle hydraulic system for controlling the movement of said vehicle, said improvement comprising:
a wheelchair ramp subassembly including a ramp member pivotably attached relative to said frame of said vehicle; and
a ramp hydraulic system configured to control the pivoting action of said wheelchair ramp member,
said vehicle and ramp hydraulic systems isolated from and separated from each other such that one does not include the fluid of the of the other.

2. The vehicle as claimed in claim 1, wherein said vehicle hydraulic system includes a vehicle hydraulic fluid and wherein said ramp hydraulic system includes a ramp hydraulic fluid.

3. The vehicle as claimed in claim 2, wherein said ramp hydraulic fluid has a different operating characteristic than said vehicle fluid.

4. The vehicle as claimed in claim 1, wherein said ramp hydraulic system includes an electric motor which drives a pump which pressurizes said ramp hydraulic fluid, which drives said rotary actuator, which causes said said pivoting movement of said ramp.

5. The vehicle as claimed in claim 1, wherein said ramp hydraulic system includes an electric motor which drives a pump which pressurizes said ramp hydraulic fluid, which drives said rotary actuator, said rotary actuator having a rotating output shaft, and said wheelchair ramp assembly further comprising a linkage assembly intermediate said output shaft and said pivoting ramp member, such that said motor drives the pivoting movement of said ramp member.

6. A method of assembling a wheelchair ramp subassembly and attaching same to a vehicle having wheelchair access and having a vehicle hydraulic system, said method comprising the steps of:
providing a wheelchair ramp subassembly frame;
providing a ramp pivotably attached relative to said frame;
providing an electrically driven motor which drives a hydraulic pump assembly, both items attached relative to said wheelchair ramp subassembly frame;
providing a rotary actuator attached to said wheelchair ramp subassembly frame;
providing ramp hydraulics which form a closed system with said hydraulic pump assembly and said rotary actuator, said ramp hydraulics not to be commingled with said vehicle hydraulic system;
installing said wheelchair ramp subassembly frame, said electrically driven motor, said hydraulic pump assembly, said rotary actuator, and said ramp hydraulics, all as a modular unit to said vehicle; and
connecting electrical power to said electrically driven motor, such that said electrically driven motor can drive said hydraulic pump, and said hydraulic pump can pressurize the ramp hydraulics such that said rotary actuator operates said pivoting ramp.

7. A wheelchair ramp subassembly for use with a vehicle configured to provide wheelchair access, said vehicle including a wheelchair mounting location and also including vehicle hydraulics and hydraulic lines, and said wheelchair ramp assembly comprising:
a ramp frame;
an electrically powered hydraulic pump assembly attached to frame;
hydraulic pump assembly controls having control lines; and
a self-contained ramp hydraulic system operably associated with said hydraulic pump assembly,
such that said frame of said wheelchair ramp assembly is configured to be attached to said vehicle in a modular manner and such that said wheelchair ramp assembly is operable simply by attaching said electrical and control lines to said vehicle, and without the connection of said ramp hydraulic lines with said vehicle hydraulics.

8. A method of assembling a wheelchair ramp subassembly and attaching same to a vehicle having wheelchair access and having a vehicle hydraulic system, said method comprising the steps of:
providing a wheelchair ramp subassembly frame;
providing a ramp pivotably attached relative to said frame;
providing an electrically driven motor which drives a hydraulic pump assembly, both items attached relative to said wheelchair ramp subassembly frame;
providing a rotary actuator attached to said wheelchair ramp subassembly frame;
providing ramp hydraulics which form a closed system with said hydraulic pump assembly and said rotary actuator, said ramp hydraulics not to be commingled with said vehicle hydraulic system;
installing said wheelchair ramp subassembly frame, said electrically driven motor, said hydraulic pump assembly, said rotary actuator, ramp hydraulics, all as a modular unit to said vehicle; and
connecting electrical power to said electrically driven motor, such that said electrically driven motor can drive said hydraulic pump, and said hydraulic pump can pressurize the ramp hydraulics such that said rotary actuator operates said pivoting ramp.

9. A method of assembling a wheelchair ramp subassembly and attaching same to a vehicle having wheelchair access, having a vehicle hydraulic system, and having an electrical system, said method comprising the steps of:
providing a wheelchair ramp subassembly which includes as an input electrical power, and as an output the control of a pivoting wheelchair ramp to allow selective retraction and extension of said ramp, said wheelchair ramp subassembly including internal, self-contained hydraulics which are not connected to said vehicle hydraulic system;
installing said wheelchair ramp subassembly to said vehicle;
connecting said electrical system of said vehicle to said electrical input of said wheelchair ramp subassembly; and
operating said wheelchair ramp subassembly between a retracted and an extended position.

10. A wheelchair ramp assembly for use with a vehicle, said ramp assembly including:
a frame member;
a ramp member pivotably attached relative to said frame member;
an elongate first linkage member having opposing first and second ends and a longitudinal axis, said first end pivotably attached to one of said frame member and said ramp member; said first linkage member defining a transverse bushing hole having an axis substantially perpendicular to said longitudinal axis of said first linkage member
an elongate second linkage member having opposing first and second ends and a longitudinal axis, said first end pivotably attached to the other of said frame member and said ramp member, said second linkage member defining proximate its second end a transverse bushing hole having an axis substantially perpendicular to said longitudinal axis of said second linkage member, said second linkage member including a transverse pin hole extending through its thickness along the wall, said transverse pin hole having a hole axis being perpindicuar to said longitudinal axis of said second linkage member and also perpendicular to said hole axis of said transverse bushing hole
a bushing assembly, said bushing assembly itself comprising:
a main portion, said main portion including a head portion, an intermediate bearing portion, and a fixing portion, said fixing portion including a through transverse bore configured to accept a length of said pin member; and
a pin member configured to extend through said transverse bore of said fixing portion and to extend through said transverse pin hole of said second linkage member, and to provide a frictional connection between said fixing portion and said second linkage member,
such that when assembled, said pin member attaches said main portion to said second linkage member, and said first linkage member pivots relative to said second linkage member and said main portion.

11. A wheelchair ramp assembly for use with a vehicle, said ramp assembly comprising:
a ramp assembly frame configured to be mounted to said vehicle;
a ramp assembly pivotably attached relative to said frame, said ramp assembly including at least one side wall being substantially platelike and including two opposing primary planar surfaces;
a first linkage member being substantially platelike and including opposing primary planar surfaces;
a second linkage member being substantially platelike and including opposing primary planar surfaces; and
first and second substantially similar bushing members, each of said bushing members having a head portion defining a top face,
said first bushing member mounted such that its top face is substantially flush with said outside primary planar surface of said side wall,
said second bushing member mounted such that its top face is substantially flush with the primary planar surface of one of said linkage members.

12. A wheelchair ramp assembly for use with a vehicle, said ramp assembly comprising:
a ramp assembly frame configured to be mounted to said vehicle;
a ramp assembly pivotably attached relative to said frame, said ramp assembly including at least one side wall being substantially platelike and including two opposing primary planar surfaces;
a first linkage member being substantially platelike and including opposing primary planar surfaces;
a second linkage member being substantially platelike and including opposing primary planar surfaces; and
a bushing member having a head portion defining a top face,
said bushing member mounted such that its top face is substantially flush with the primary planar surface of one of said linkage members.

13. A wheelchair ramp assembly for use with a vehicle, said ramp assembly comprising:
a ramp assembly frame configured to be mounted to said vehicle;
a ramp assembly pivotably attached relative to said frame, said ramp assembly including at least one side wall being substantially platelike and including two opposing primary planar surfaces;
a first linkage member being substantially platelike and including opposing primary planar surfaces;
a second linkage member being substantially platelike and including opposing primary planar surfaces; and
a bushing member having a head portion defining a top face,
said bushing member mounted such that its top face is substantially flush with said outside primary planar surface of said side wall.
